(19) United States
(12) Patent Application Publication
(10) Pub. No.: US 2006/0259819 A1
(43) Pub. Date: Nov. 16, 2006

(54) Automated Method for Self-Sustaining Computer Security

(76) Inventor: Matthew A. Connor, Earlysville, VA (US)

Correspondence Address: WOODS, ROGERS, P.L.C., 1505 LONDON ROAD, CHARLOTTESVILLE, VA, 22902-8681, US

(21) Appl. No.: 11/382,530

(22) Filed: May 10, 2006

Related U.S. Application Data
(60) Provisional application No. 60/594,848, filed on May 12, 2005.

(51) Int. Cl. G06F 11/00

(52) U.S. Cl. 714/38

(57) ABSTRACT

A method for enhancing computer security and efficiency by providing automatic installation and maintenance of security applications including anti-virus, anti-spyware and a firewall along with continuous monitoring of the status of critical security programs to ensure that they are performing optimally and without significant interruption. The method also provides for maintenance of a user's computer.

### CROSS-REFERENCES TO RELATED APPLICATIONS

The present application claims the benefit of the earlier filing date of U.S. Provisional Patent Application Ser. No. 60/594,848, filed May 12, 2005, which is incorporated by reference herein in its entirety.

### TECHNICAL FIELD

The subject invention relates generally to a method for substantially enhancing the level of protection and efficiency of a computer. More particularly, the method provides an automated, self-sustaining, high level of defense against malicious incursions into personal computers which are connected to the Internet, as well as improving the performance of any RW storage devices connected to such computer.

### BACKGROUND OF THE INVENTION

The Internet in many ways resembles a field of war with many competing interests, some benevolent and some malevolent, but all seeking access to a user's computer (PC). The frontline of defense against such incursions is anti-virus, firewall and anti-spyware applications along with regular computer maintenance. The normal computer user is not trained to, nor interested in, actively participating in the defense of his or her computer. Consequently, if any part of the defensive mechanism ceases functioning, the PC becomes susceptible to damage by malevolent external software.

Although there are security suites on the market, no proper standard for proper PC security and maintenance has as yet been established or enforced by existing software. For instance, almost every security suite provides one anti-virus, one firewall and one anti-spyware application, but these applications do not provide sufficient protection. For example, no anti-spyware application provides protection against 100% of the known instances of spyware. Moreover, since spyware morphs and adapts so quickly that it is difficult to stay current with existent threats. Thus, there is only a modest overlap between the spyware recognized by existing programs. In order to achieve more than 85% protection, it is necessary to install and use at least two anti-spyware programs on any given PC. One problem in this regard is that software companies are motivated by profit maximization and generally market only one anti-spyware program since they do not want to compete against themselves nor waste valuable research and development resources in duplicated efforts. Therefore, the typical PC user erroneously believes that buying an Internet security suite type of application provides virtually worry-free security. Furthermore, all security products offered by such developers are typically only those created or owned by the developer resulting in a great lack of flexibility and choice for the PC user.

Another problem is that security suite applications generally provide PC users with only the illusion that their computer is protected adequately at all times. For example, although a central control panel to view the status of a PC's security may be provided, they have limited functionality. The user must actively access the components of the security suite in order to manage them. So, in the case of anti-virus applications, if an external virus succeeds in bringing down the anti-virus application by forcing a buffer overflow or accessing the program control area of a PC to disable the anti-virus program by turning it off, most existing security suites do not notify the PC user of the problem since they do not provide real time monitoring and reporting on security application status. Consequently, it may be some time before the user even realizes that the anti-virus program has not been running, thereby permitting the virus to implant itself in the PC's boot sector, kernel or elsewhere where it will be difficult to dislodge once the anti-virus program is finally up and running again. The virus may have proliferated itself so far into the PC's BIOS that it may be quicker, easier and less expensive for the PC user to dispose of the computer and buy a new one rather than engage a computer technician seeking repair services. Even those rare security suites which do monitor security applications and do notify users when those applications have been successfully attacked or otherwise disabled do nothing to prevent a virus from embedding itself in a user's computer and potentially causing significant damage.

Still other problems arise depending on the method used by security suites to perform updating. Some such suites are dependent on a centralized server to provide updating for all applications for all users at one location through one centralized database. Not only is the update procedure handled centrally but the central server is also responsible for comparing application updates to what the remote client reports having. This arrangement makes the client unnecessarily, totally dependent on the proper functioning, availability of and accuracy of a single central server. Having decisions concerning requests for and implementations of updates handled locally at a client computer would provide far greater flexibility and efficiency than the central server model.

What is needed, then, is a system and method for taking control of PC defenses which works in the background and is invisible to the PC user as it functions. Such a system and method should ascertain the level of a PC's defensive capabilities, improve its defenses as much as possible and constantly monitor those defenses to repair or restore them when necessary.

### SUMMARY OF THE INVENTION

The present invention relates to a method for enhancing the security of a user's Internet-connected computer and improving its efficiency. More particularly, the method enables a security provider to automatically control damaging and objectionable objects on a user's computer. After the computer user has accessed the web site of the security provider, a secure user account is established and supported security applications along with a supervisory application are installed on the user's computer. The user then selects a maintenance time of day. The supervisory and security applications are then launched and their operation is monitored. If the operation of any security application or the supervisory application is disrupted, such application is immediately relaunched. At the selected maintenance time, updating of all security applications and the supervisory application occurs. Thereafter, the computer is scanned for objectionable and potentially damaging objects which are either cleaned, removed from or quarantined within the computer, as necessary. When the scans have been completed, internal maintenance of computer systems is carried out to improve computer efficiency. Finally, a log showing the history of maintenance operations performed is updated.

### BRIEF DESCRIPTION OF THE DRAWINGS

The foregoing and other objects, aspects and advantages of the invention will be better understood from the following detailed description of the invention with reference to the drawings, in which

FIG. 1 is an overview in block diagram form of the method of this invention.

FIG. 2A and FIG. 2B are detailed views in block diagram form of the installation process of this invention.

FIG. 3 is a detailed view in block diagram form of the initial download process of this invention.

FIG. 4 is a detailed view in block diagram form of the protection process of this invention.

FIG. 5A, FIG. 5B and FIG. 5C are detailed views in block diagram form of the maintenance process of this invention.

### DETAILED DESCRIPTION OF THE INVENTION

This method of this invention is intended to be used with any single or multi-user computer although in the preferred embodiment it is designed for use in a WINDOWS® (a registered trademark of Microsoft Corporation) operating system (OS) environment of WINDOWS 2000® or later with an optional Dot Net (.Net) framework. Thus, in the preferred embodiment, a computer having at least a Pentium 133 processor, 32 MB of RAM, a data storage device with at least 200 MB of space and an Internet Explorer browser version 4.0 or higher are required. Nevertheless, the method of this invention is easily adapted for use on other OS platforms such as, but not limited to, LINUX® (a registered trademark of Linus Torvalds), UNIX® (a registered trademark of Unix System Laboratories, Inc.), or Apple MACINTOSH® (a registered trademark of Apple Computer, Inc.).

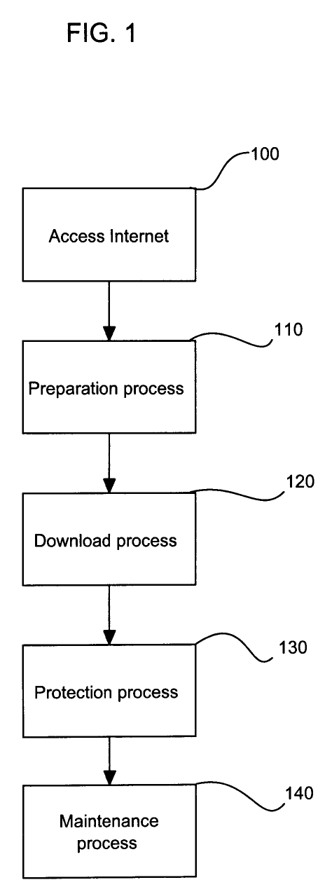

For a more detailed understanding of the invention, reference is first made to FIG. 1 of the drawings which presents an overview in block diagram form of the method of the preferred embodiment of this invention. At 100, a remote computer user accesses the Internet web site hosted by a security provider by any of a variety of available means, preferably with a broadband or high speed connection, in order, at 110, to prepare the user's computer for the download and installation of a supervisory application (hereinafter “SA”) used to execute the method of this invention. Once SA has been successfully installed on the user's computer, SA further downloads at 120 any necessary, additional software found to be absent from the user's computer. Active protection of the user's computer is automatically initiated by SA at 130. Thereafter, at a pre-specified time each day, SA at 140 maintains itself, the user's computer and all other software which SA is responsible for monitoring on the user's computer.

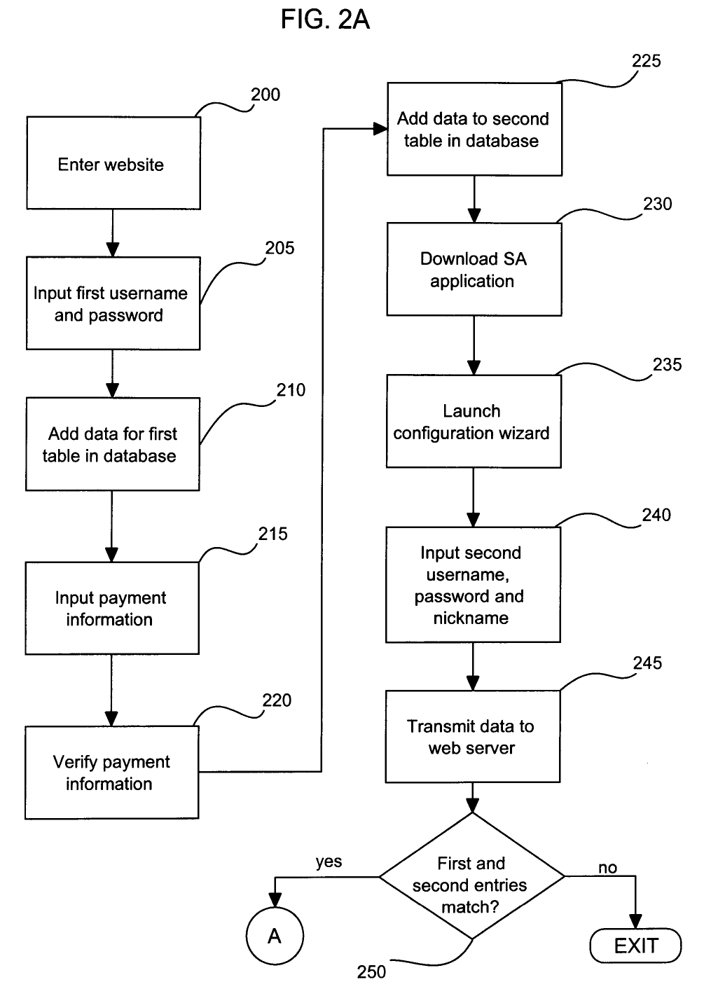

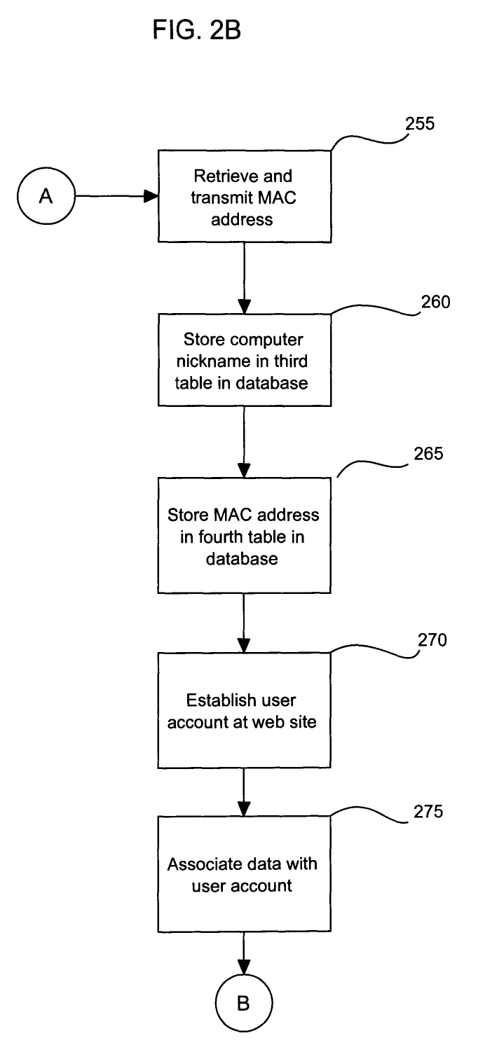

Turning now to FIG. 2A and FIG. 2B, detailed views in block diagram form of the preparation process 110 of the method of this invention are presented. At 200, the remote user enters the web site at which SA is maintained. Then, at 205, the user enters registration information including a first username and password at the web site. This information is added at 210 to a first table in a database maintained in the server for the web site. The user further enters payment information at 215. This information can be entered in the form of authorization to charge a credit card, to draft funds electronically from one of the user's accounts maintained at a financial institution or through a charge made through a third party, such as, for example, but not limited to, PAYPAL® (a registered trademark of PayPal, Inc.). The payment information is sent to a merchant account server for verification at 220. After verification, at 225 the payment information is encrypted and then transferred to and maintained in a second table in the database in the server for the SA web site. Next, the application for SA is downloaded to the user's computer over the Internet and is installed on the user's computer at 230. A configuration wizard launches at 235. The user enters their username and password and nickname of the computer which they are using at 240. This data is transmitted to the SA web server at 245. Upon successful comparison at the SA web server of the second username and password entered by the user on his local computer with the first username and password at 250, SA retrieves the MAC address of the user's computer and transmits that data to the SA web site at 255. Although many software applications use an encrypted security key having a unique algorithm to deter piracy, the concept of activating software with data identifying a computer is relatively new. The simplest and least obtrusive way of ensuring accurate accounting for software in use is by using a MAC address in combination with a username and password to provide an accessible, relatively reliable, unique identification for the computer on which software is installed. The computer nickname is stored in a third table in the database at 260, and the MAC address is stored in a fourth table in the database at 265. Upon storage of all of the user-specific data in the first, second, third and fourth tables and its association with a particular account, registration and activation of a user account are complete at 270.

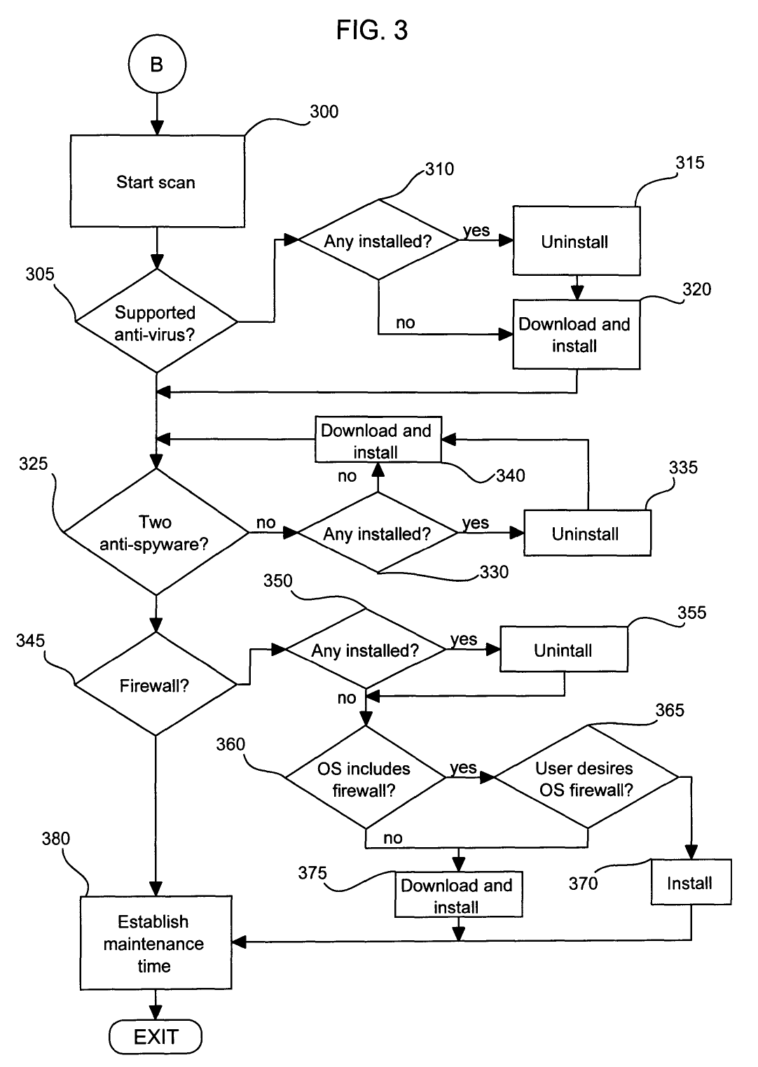

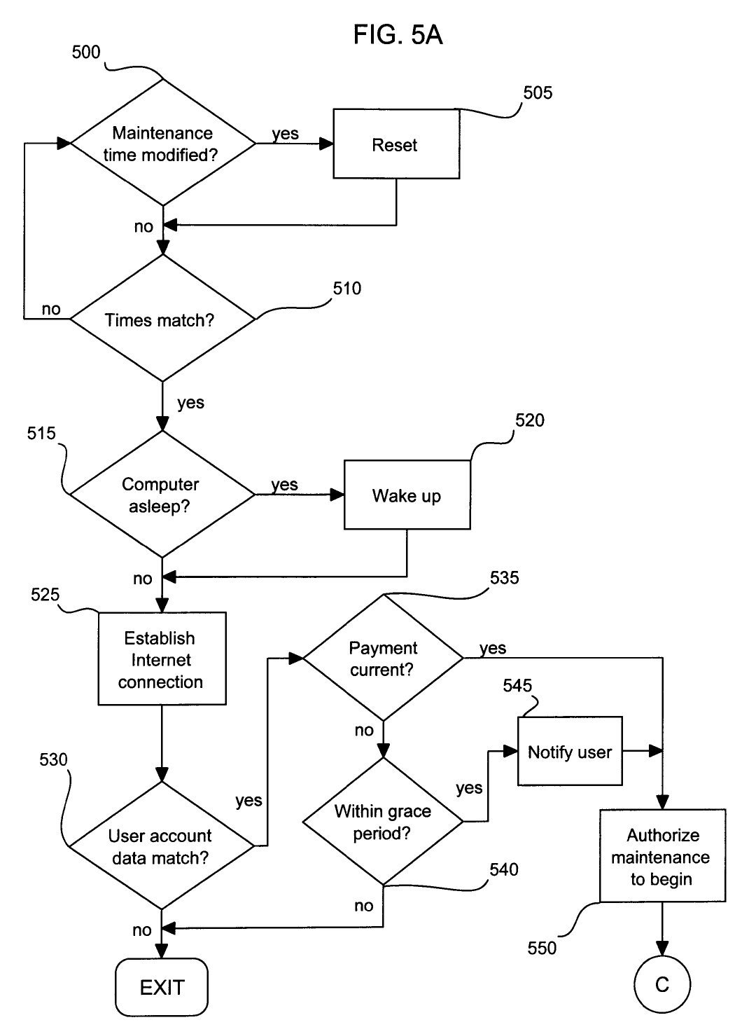

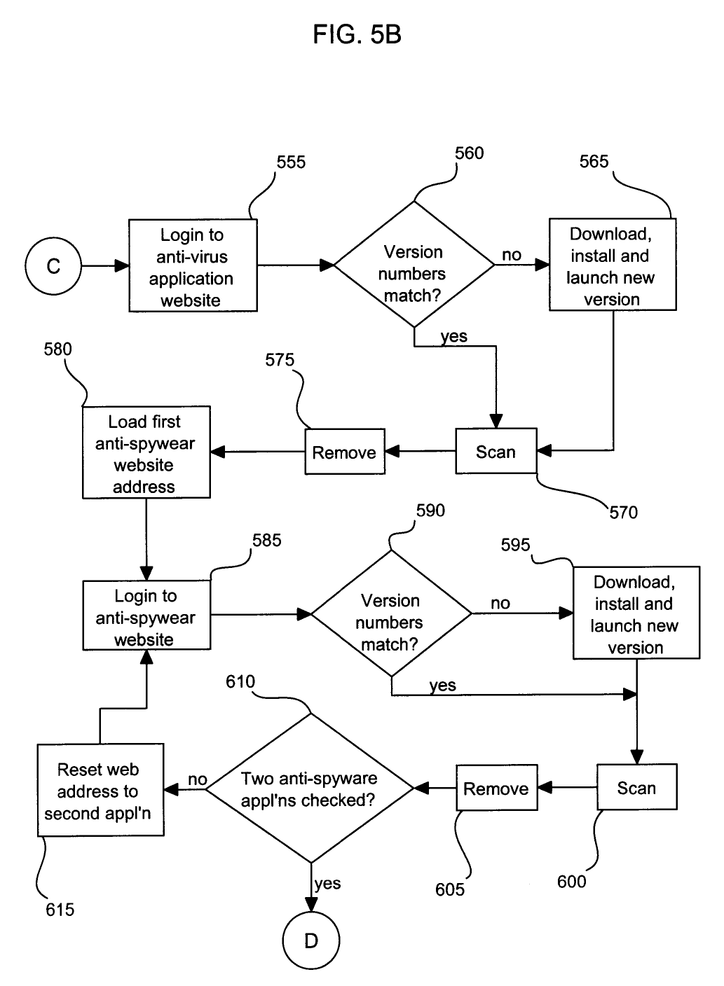

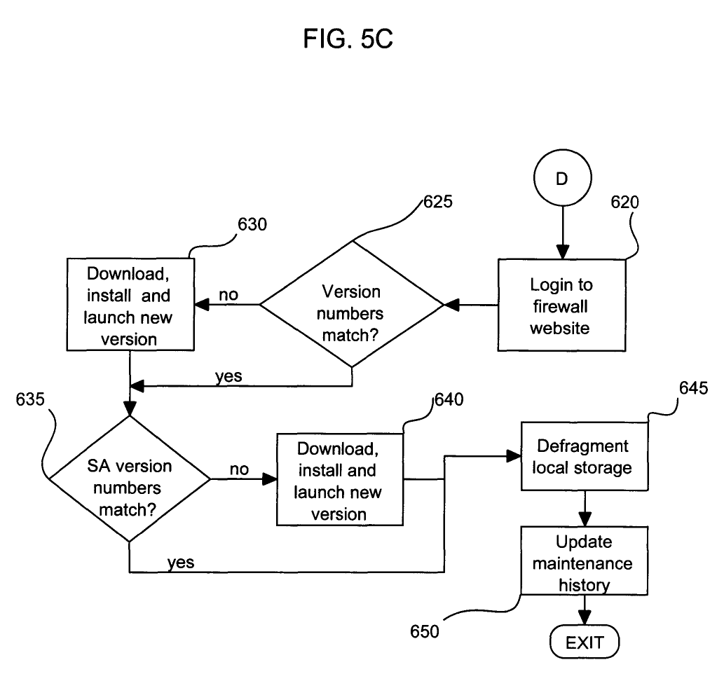

In FIG. 3, a detailed view in block diagram form of the download process 120 of the method of this invention is presented. This download process is controlled by the configuration wizard of SA. At 300, SA initiates a scan of the user's computer. This scan determines at 305 whether the user's computer already has installed thereon an anti-virus application which is supported by SA. If not, a further determination is made at 310 whether a non-supported anti-virus application is installed on the user's computer. If so, that application is uninstalled at 315, and a supported application is automatically downloaded from a third-party web site and installed on the user's computer at 320. At 325, a further scan is performed to determine if the user's computer has installed thereon at least two different supported anti-spyware applications. If not, a further determination is made at 330 whether a non-supported anti-spyware applications is installed on the user's computer. If so, each such application is uninstalled at 335, and a supported anti-spyware application is automatically downloaded from a third-party web site and installed on the user's computer at 340. Processing then returns to 325 to recheck whether at least two different supported anti-spyware applications are installed. If not, processing returns again to 330, and, if so, SA proceeds to 345 where yet another scan is performed to determine if the user's computer has installed thereon a supported firewall application. If not, a further determination is made at 350 whether a non-supported firewall is installed on the user's computer. If so, such application is uninstalled at 355, and still another check is performed at 360 to determine whether the OS of the user's computer includes a firewall. For example, this would be the case with WINDOWS XP®, Service Pack 2. If so, the user is given a choice whether to use the integrated OS firewall or another firewall option provided by SA at 365. There may be limitations to using integrated firewalls such as the ability to provide only one-way protection, for example, against incoming access. SA can also be configured to advise the user of such limitations. At 370, the integrated firewall would be installed, while at 375 a firewall is automatically downloaded from a third-party web site from the Internet and installed on the user's computer. Then, at 380, the user is requested to establish by selection a time of day when daily maintenance, as discussed below with regard to FIG. 5A, FIG. 5B and FIG. 5C, is to be undertaken. Since maintenance is so computer intensive and of such long duration, this time is typically chosen to be during the middle of the night when the computer is not likely to be engaged for any other purpose. At this point, the process controlled by the configuration wizard is complete and the security function of SA is engaged and remains so until either the user disengages SA or the user's account is determined not to be paid up to date, as described below. If during the installation process, any particular security application which is installed on the user's computer offers the option of a tutorial for further setup details and to better understand the functioning of an application, SA offers the user the option of temporarily exiting the configuration program to examine such tutorials. In the preferred embodiment, users are not given the option of choosing between various security applications of the same kind, such as between several anti-virus applications, for installation since most users are not capable of distinguishing between such application. Thus, the decisions are made for them by SA. In an alternative embodiment, such choices are provided.

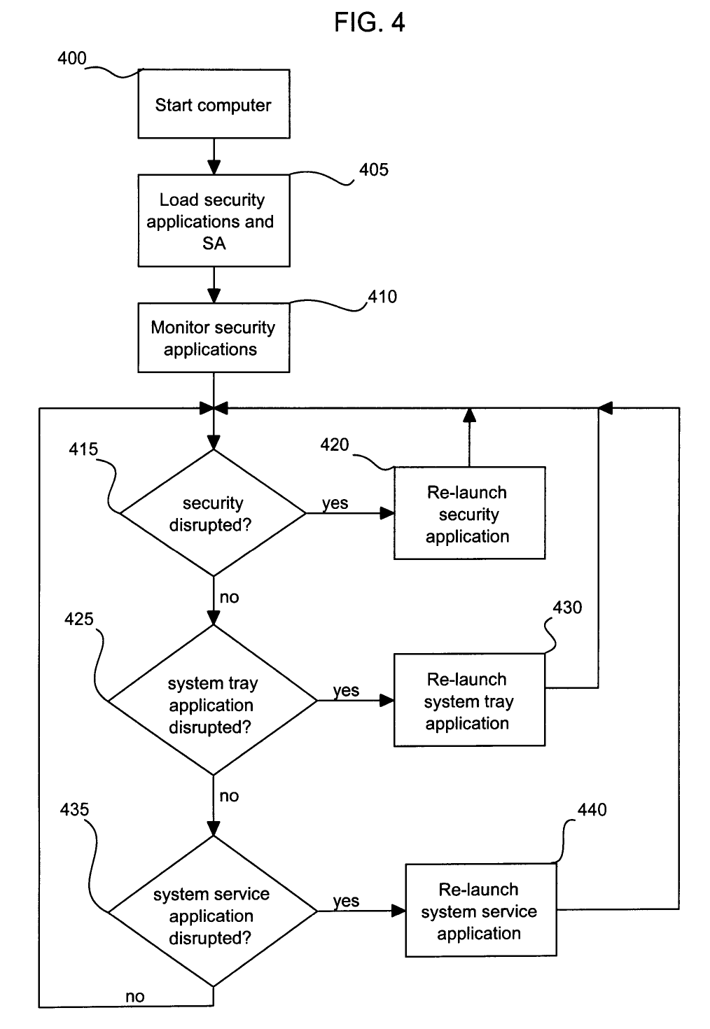

FIG. 4 shows in block diagram form the active protection process 130 of the method of this invention. Whenever, a user starts a computer protected by SA at 400, the anti-virus, anti-spyware and firewall applications supported by SA and installed on that computer are automatically loaded in a WINDOWS® operating system as part of the system tray application at 405. As part of the same process, SA is also loaded and its presence is also shown on the system tray. When loading is completed, SA begins constantly monitoring each of the supported anti-virus and firewall security applications at 410. If any one or more of these security applications should stop functioning or close, other than at the computer user's instruction, as determined at 415, SA immediately re-launches the disrupted security application(s) at 420. For purposes of this disclosure, immediately means re-launching of an application prior to damage or a malicious incursion to the user's computer occurring. SA also includes a system service application which is a process running in the background of the operating system and providing additional services to the OS and other applications running on the computer. SA further includes a system tray application which is responsible for placing an icon showing the presence of SA on the system tray and, together with the SA system service application, for maintaining SA. The system service application constantly monitors the functioning of the system tray application at 425. Should the system tray application cease functioning or malfunction, the system service application immediately re-launches the disrupted system tray application at 430. The system tray application, in turn, monitors the functioning of the system service application at 435. Should the system service application cease functioning or malfunction, the system tray application immediately re-launches the disrupted system service application at 440. All of the monitoring functions previously described operate in a continuous loop so long as the computer itself is turned on.

The constant monitoring of security applications on a user's computer by the method of this invention along with the capability to immediately re-launch a security application is particularly valuable in the control of viruses. Viruses are typically written in machine language because they have to be short and compact. In order to be effective, their code must be very exact and completely linear. Therefore, object-oriented languages are seldom, if ever, used in writing viruses. An example of this would be a virus which scans the Internet looking for valid IP addresses. When such an address is found, the virus scans the system at that particular IP address for a particular open port that the virus is designed to exploit. If it finds the vulnerability/weakness at that address, it exploits that weakness and then installs itself. A machine code virus, since it is linear, simply performs one function after another—in other words once it determines that the virus software at a user's computer is incapacitated, it installs itself and executes without rechecking whether the virus software has stayed down since, to do so would make the virus more identifiable and hinder its ability to bring down the anti-virus application. According to the method of this invention, once an anti-virus program becomes nonfunctional, it is re-launched again automatically and immediately without intervention from or involvement of the user, although the user could be notified of the occurrence, if desired. Unless a virus is a “0” day virus (brand new), all anti-virus applications will be able to recognize it. Since this invention results in such fast re-launch of a computer's anti-virus software, it prevents most viruses from implanting themselves. At the point of re-launch, a virus is still likely to be in active memory as an active, running process. Thus, it can still be detected and removed by anti-virus software. The speed with which the user's anti-virus software can be re-launched can be further enhanced by use of a faster processor but will, in any event, be swift enough to greatly improve virus control over other methods known in the art. Furthermore, the method of this invention provides substantially continuous control and removal or isolation of damaging and objectionable objects on the user's computer while that computer is in operation.

In order to ensure current and up-to-date protection, SA and the respective supported security applications must be periodically maintained, preferably daily, at a time selected by the user at 335. Such maintenance requires that the user's computer be turned on, although it may be in a “sleep” state such as hibernate or stand-by. The maintenance process 140 of this invention is shown in block diagram in FIG. 5A, FIG. 5B and FIG. 5C. At 500, SA checks whether the time selected by the user at 335 during initial configuration has been modified. Such a modification may be made by the user through a software control panel accessible by the user through the icon representing SA which appears on the system tray. If there has been a modification, the scheduled time is reset at 505, and SA checks for the current time at 510 to compare that time to the maintenance time set by the user. If there is a match, SA checks at 515 whether the user's computer is asleep and, if it is, SA wakes up the user's computer at 520 to bring it to an active state. SA then establishes a secure Internet connection at 525 preferably through port 443 (or any equivalent Secure Sockets Layer port) on the user computer. A comparison of the username, password, nickname and MAC address stored on the user's computer with that stored on the server at the SA web site under the user's account match is performed at 530. If these do not match, the process is exited as the user is not entitled to the service. If these do match, a further check is performed at 535 to see if payments for the user's account are current. If not, another check is performed at 540 to determine if the user account is still within a SA-specified grace period allowed for bringing the account current. If not, the process is exited. If so, the user is reminded of the necessity to make the required payments at 545. Such advisory may either be an email message or a notice appearing on the user computer's screen, and authorization is sent to the user's computer to proceed with the maintenance process at 550.

Where there is no update module included with a third-party application or this module is not functioning, SA logs in directly to the web site for the supported application in order to perform maintenance. Otherwise, the third-party update module itself is called, commanded or accessed in order for it to assume the update function. This same procedure is followed with regard to updates and maintenance for all third-party applications. At 555, SA takes whatever action is required to effect access and login to the web site of the supported anti-virus application. A comparison of application version numbers is conducted at 560. If the version numbers do not match, an update occurs at 565 using a subroutine in which SA conducts an FTP transfer of the newer files from the web server to the local user's computer. The newer version is then installed either by copying the newer file(s) to the appropriate place(s) on the local computer, or, in the case of an update to an MSI file, by sending a series of commands to the newly downloaded installation application informing it to conduct a silent and automatic installation of the application. SA is capable of automatically generating a variety of control commands including, but not limited to, command line calls, sending keyboard shortcuts, moving the cursor and clicking appropriate hyperlink and other buttons and by making API calls. These control commands are used as necessary during each maintenance procedure. The anti-virus application is then re-launched, and maintenance is continued. The method of this invention uses the security and maintenance applications installed on the user's computer to conduct daily maintenance over the Internet of those third-party provided security applications. If either no match is found or a new version has been launched, at 570 the user's computer is then also scanned to locate and at 575 remove, clean or quarantine any identified viruses. The web address of the first anti-spyware application is loaded at 580 and log in to that web site occurs at 585. A comparison of application version numbers is conducted again at 590, and, if no match is found, the new version of the first anti-spyware application is downloaded, installed and launched at 595. Regardless, the user's computer is then also scanned to locate spyware at 600. Since anti-spyware programs often identify cookies and other items which the user may wish to retain on his computer, SA is configured to examine and either remove, clean or quarantine at 605 only objects found during spyware scans which are clearly critical and objectionable or potentially damaging. Non-threatening objects are not removed. SA then checks whether maintenance has been performed on at least two anti-spyware applications at 610. If not, the maintenance address is reset by SA to the web address for the second anti-spyware application web server at 615, and this address is then accessed for maintenance by returning to 585. Once both anti-spyware applications have been maintained and scans/removals have been completed by both, log in to the web site for the firewall application occurs at 620. A comparison of application version numbers is conducted at 625, and, if no match is found, the new version of the firewall application is downloaded, installed and launched at 630. If either a match is found at 625 or an upgrade has occurred at 630, a comparison is next made between the version number of SA stored on the user's computer and that stored on the SA web server at 635. If the version numbers do not match, the newer version is downloaded from the SA web server, installed and launched at 640. SA application maintenance is performed after all other maintenance since it may necessitate a restart of the user's computer which could produce timing problems with maintenance of other security applications. Finally, SA loads and runs a disk defragmenting application at 645 which may be native to SA or may be supplied by a third party or with the OS. Defragmenting is performed on whatever number of storage devices are connected to the user's computer. Thereafter, the maintenance history for the user's computer is updated at 650. This history is kept by collecting and reading the log files of the third-part applications and compiling the date in a user-friendly format. At this point, the maintenance process is complete and is exited. As maintenance occurs for each security application, SA monitors its progress to ensure it occurs properly and to make any routine decision on behalf of the user. If a decision is called for outside of SA's pre-programmed capabilities, that decision is left to the user. For example, if the anti-virus application discovers a virus in a file which it was not able to clean, delete or quarantine, the computer user could be provided with a link to a web site with details on how to manually extract the virus. SA allows each area of maintenance a set period of time in which to complete its functions. As soon as the maintenance in one area is completed, SA continues on to the next maintenance area. If it is not completed in the allotted time, then SA continues on to the next step. Although in the preferred embodiment, the anti-virus security application is updated first since viruses pose the greatest threat to computer, the order of application maintenance can nevertheless be varied from that described above without detrimental effects on the method of the invention.

Once SA is installed and running, it is entirely self-sustaining and automatic so long as the required fees are paid. Nevertheless, the user does have access to a control panel through which any one or more supported security application can be controlled, disabled or enabled. This differs from other security suites providing control panels which do nothing more than identify installed applications. In an alternative embodiment, instead of downloading security and/or other applications from a third-party site, some or all applications may be stored and maintained on SA's own web site thereby eliminating the need to access a third-party web site and making the maintenance process speedier and more efficient. In yet a further embodiment, more than one anti-virus, more than two anti-spyware and more than one firewall applications are downloaded, installed and maintained on a user's computer. In another embodiment, the computer use is given the option of additionally, separately purchasing, downloading and installing at least one supported, more complex security application from at least one third-party vendor rather than, or in addition to, using those applications supplied through the SA web server. In still another embodiment, in addition to disk-defragmentation, SA performs further user computer maintenance including, but not limited to, looking for disk errors with a Check Disk application; backing up local disk data either on- or off-site through the SA web site, checking the local computer registry for inconsistencies, errors and uncollected garbage; and optimizing start-up of the local computer by permitting the user to select which non-essential programs should launch when the OS boots up; updating operating system and other non-security software installed on the local computer.

The foregoing invention has been described in terms of the preferred embodiment. However, it will be apparent to those skilled in the art that various modifications and variations can be made to the disclosed apparatus and method without departing from the scope or spirit of the invention.

What is claimed is:

1. A method for a security provider hosting a web site to enhance the security of a remote user's Internet-connected computer by automatically and substantially continuously controlling damaging and/or objectionable objects on that computer with supported security applications managed by a supervisory application and to improve the efficiency of that computer comprising:
accessing the security provider's web site on the Internet;
establishing a secure user account with the security provider;
installing supported security applications on said computer;
selecting a daily recurring maintenance time for that computer;
launching all of the security applications on that computer;
monitoring the security applications for a disruption of operations;
if the operation of a security application is disrupted, immediately re-launching said security application and returning to monitoring;
ascertaining the proper maintenance time;
when the maintenance time occurs,
updating each security application and the supervisory application, as needed;
causing the computer to be scanned by at least three security applications;
after each scan, either cleaning or removing any objects determined to be damaging or objectionable from the user's computer or quarantining said objects within the user's computer
performing internal computer maintenance; and
creating and keeping current a history of computer maintenance performed.

2. The method of claim 1 wherein, while connected over the Internet to the web site of the security provider, establishing further comprises:
inputting a username and password which is stored in a first table in a database maintained at the security provider's web site;
further inputting payment information;
verifying the validity of said payment information;
storing said payment information in a second table in said database;
downloading the security provider's supervisory application to and installing said application on the computer;
re-entering said username and password as well as a nickname for the computer;
matching the re-entry of said username and password with the first input of said username and password;
if the matching is unsuccessful, exiting the process;
retrieving the MAC address of the computer;
further storing said computer nickname in a third table in said database;
additionally storing said MAC address in a fourth table in said database;
establishing a secure user account;
associating the data stored in said first, second, third and fourth tables with said user account.

3. The method of claim 1 wherein installing further comprises:
checking if at least one supported anti-virus application is installed on said computer;
if not, testing if any non-supported anti-virus application is installed on said computer;
if so, uninstalling all said non-supported anti-virus applications;
if not, downloading and installing at least one supported anti-virus application on said computer;
further checking if at least two supported anti-spyware applications are installed on said computer;
if not, further testing if any non-supported anti-spyware applications are installed on said computer;
if so, uninstalling all said non-supported anti-spyware applications;
if not, downloading and installing at least one supported anti-spyware application on said computer and returning to further checking;
still further checking if at least one supported firewall application is installed on said computer;
if not, still further testing if any non-supported firewall application is installed on said computer;
if so, uninstalling all said non-supported firewall applications; and
if not, downloading and installing at least one supported firewall application on said computer.

4. The method of claim 3 wherein one supported anti-virus, two supported anti-spyware and one supported firewall application are installed on the computer.

5. The method of claim 1 wherein launching further comprises:
starting the supervisory security application which, in turn, launches a system service application and a system tray application which are a part thereof;
further launching at least one anti-virus application, at least two anti-spyware applications and at least one firewall; and
placing an icon indicating the presence of the supervisory security application onto the system tray.

6. The method of claim 5 wherein monitoring further comprises:
determining whether operation of said system tray application of the supervisory application has been disrupted and, if so, immediately re-launching said system tray application; and
further determining whether operation of said system service application of the supervisory application has been disrupted and, if so, immediately re-launching said system service application.

7. The method of claim 1 wherein ascertaining comprises:
checking whether said selected maintenance time has been modified; and
if so, resetting the maintenance time to the new selected maintenance time.

8. The method of claim 1 which, prior to updating each security application, further comprises:
determining if the computer is in a sleep state;
if so, waking the computer up;
establishing an Internet connection;
verifying that the user account is active; and
authorizing computer maintenance to begin.

9. The method of claim 8 wherein verifying further comprises:
matching said username, password, nickname and MAC address on the computer with the data stored in the first, second, third and fourth tables stored in said database;
ascertaining if all currently due payments for the user's account have been made;
if said payments have not been made, determining if the present date is within a grace period set by the supervisory security application after the due date; and
if not, exiting the application.

10. The method of claim 1 wherein each security application and the supervisory application have a separate version number associated therewith and updating further comprises:
logging in to the web site for each application;
comparing the version number of that application installed on the user's computer with the version number for that application stored on the respective web site therefor; and
if the version numbers are not equal, downloading and installing the version thereof accessible at the web site onto the user's computer.

11. The method of claim 1 wherein said three security applications include at least one anti-virus application and at least two anti-spyware applications.

12. The method of claim 1 wherein performing further comprises defragmenting at least one local storage device on the user's computer.

13. The method of claim 1 wherein updating further comprises providing the user with the option of separately purchasing, downloading and installing at least one supported security application from at least one third-party vendor.

14. The method of claim 12 wherein performing still further comprises one or more selected from the group consisting of check disk operations, backing up local disk data, checking the user's computer registry for inconsistencies, errors and uncollected garbage, optimizing start-up of the user's computer by permitting the user to select which non-essential programs should launch when the computer boots up; updating the operating system and other non-security applications installed on the user's computer.

15. The method of claim 1 wherein the supported security applications and a supervisory application are purchased, downloaded and installed on more than one of a user's computers.

16. The method of claim 15 wherein the MAC address of each computer is used to distinguish between computers and to ascertain for which computer payment verification can be made.

17. A method for providing enhanced security to an Internet-connected computer on which a supervisory application, at least security application one and launched comprising:
monitoring each of said security applications by means of the supervisory application for a disruption of operations; and
if the operation of an application is disrupted, immediately re-launching the disrupted application and returning to monitoring.

18. The method of claim 17 wherein the security applications include at least one anti-virus application, at least two anti-spyware applications and at least one firewall application.

19. The method of claim 17 wherein the supervisory application further launches a system service application and a system tray application which thereafter mutually monitor the operation of each other for disruptions and are capable of re-launching each other should a disruption be detected.

20. A method for automatically updating at a pre-selected time of day at least one third-party security application having a version number associated therewith and a supervisory application having a version number associated therewith, each of which has been installed on an Internet-connect computer and each of which can be updated from an Internet web site comprising:
sequentially logging in to the web site for each security application and the supervisory application beginning at the pre-selected time each day;
comparing the version number of each application installed on the user's computer with the version number for that application stored on the respective web site therefor; and
if the version numbers are not equal, downloading and installing the version thereof accessible at the web site onto the user's computer.
